(19) United States
(12) Patent Application Publication
(10) Pub. No.: US 2024/0335872 A1
(43) Pub. Date: Oct. 10, 2024

(54) METHOD FOR PRODUCING A FLUID FLOW-THROUGH COMPONENT FOR A HEAT EXCHANGER

(71) Applicant: MAHLE INTERNATIONAL GMBH, Stuttgart (DE)

(72) Inventors: Michael KRANICH, Gemmrigheim (DE); Thomas SCHIEHLEN, Eislingen (DE); Robin WIGENA, Magstadt (DE); Andreas KÖNIG, Mühlacker (DE); Jakob PRAUS, Stuttgart (DE)

(21) Appl. No.: 18/624,397

(22) Filed: Apr. 2, 2024

(30) Foreign Application Priority Data
Apr. 4, 2023 (DE) 102023203119.1

(51) Int. Cl. B21D 53/04; B21D 39/03; F16B 11/00

(52) U.S. Cl. CPC B21D 53/04; B21D 39/031; F16B 11/006

(57) ABSTRACT

A method for producing a component for a heat exchanger through which fluid can flow is provided. A base plate is provided, on which there is an adhesive layer formed by glue. A channel plate is placed on the surface of the base plate such that the channel plate is spaced apart from the base plate in at least one channel region to delimit at least one fluid channel, and bears on the adhesive layer in at least one bonding region to obtain a material bond with the base plate The channel plate and base plate are clamped together in and by a press, such that a material bond is formed between the base plate and the channel plate when the adhesive layer is heated in the at least one bonding region. The base plate and channel plate are placed in a cold press such that the adhesive layer that was heated in the hot press is cooled while the base plate is clamped against the channel plate.

### CROSS-REFERENCE TO RELATED APPLICATIONS

This application claims priority from German Patent Application No. DE 102023203119.1, filed Apr. 4, 2023, the entirety of which is hereby fully incorporated by reference herein.

The invention relates to a method for the production of a component for a heat exchanger through which fluid flows, and a component produced with this method. The invention also relates to a hot press for producing such a component and an assembly comprising such a hot press.

Heat exchangers normally contain metal components bordering fluid channels. These components are frequently made of individual single pieces—in a relatively complicated process—that are joined together—e.g. by soldering—in the course of the production.

This is the basis for the invention, the object of which is to find a new way to develop components for heat exchangers. In particular, the object of the invention is to obtain a simplified and particularly inexpensive method for producing a component for a heat exchanger through which fluid can flow.

This problem is solved by the subject matter of the independent claims. Preferred embodiments are the subject matter of the dependent claims.

The fundamental concept of the invention is therefore to glue a metal base plate to metal channel plate with an adhesive in order to obtain the above component, by clamping the base plate to the channel plate under heat, and then cooling the component. The pressure in combination with heating the base plate and channel plate melts the adhesive layer formed by the glue. By pressing the components together, a strong adhesion can be obtained with the glue, resulting in a durable material bond between the base plate and the channel plate.

The joining process is facilitated by heating the adhesive layer when the base plate and channel plate are heated, because this distributes the adhesive layer evenly between the two components. This substantially improves the durability of the material bond between the components. The glue is then cured when the components are cooled. This also increases the durability of the material bond between the components. The combination of clamping and heating, and then cooling the base plate and channel plate, which is an essential aspect of the invention, is carried out with a hot press and a cold press, in which the components are both clamped and heated in the hot press and clamped and cooled in the cold press.

In detail, the method according to the invention comprises three steps a) to c). In the first step a), a base plate and a channel plate are provided, to which an adhesive layer is applied, at least on sections of the surfaces of the base plate and/or channel plate. The thickness of the adhesive is preferably between 80 and 120 micrometers, ideally approx. 100 micrometers. In the second step b), the channel plate is placed on the base plate such that the channel plate is spaced apart from the base plate in order to delimit at least one fluid channel in at least one channel region, and bears on the base plate in at least one bonding region, where the adhesive has been applied to the base plate and/or the channel plate. The third step c) involves clamping the channel plate and base plate together with a hot press, which can preferably be heated, such that the adhesive is heated in the at least one bonding region between the base plate and the channel plate to obtain a material bond. This results in an optimal pressing of the channel plate to the base plate in order to obtain a material bond between these two components. This pressure is preferably only applied by the hot press to the bonding regions. This results in an optimal pressing of the channel plate to the base plate to obtain a material bond between these two components.

According to an advantageous development of the method according to the invention, the pressure is obtained with an elastic element in the hot press, which is pressed against the at least one bonding region on the channel plate. The tolerances resulting from unevenness of the base plate and channel plate, as well as tolerances in the components of the hot press, can be compensated for by this elastic element.

According to an advantageous development of the method according to the invention, it comprises a step d) after step c). In this step d), the base plate and channel plate are placed in a cold press after they have been heated in the hot press, such that the adhesive layer is cooled while under pressure. The cold press can be connected to a coolant reservoir. This ensures that the adhesive layer is sufficiently cured after it has been heated.

A channel plate can be provided in step a) that is designed such that in step b), at least two, preferably more, bonding regions, and at least two, preferably more, channel regions, are formed. A separate fluid channel can be created in this manner by the base plate and a respective channel region, which is sealed against the external environment of the component. Furthermore, adjacent fluid channels are separated from one another by respective bonding regions.

In another preferred embodiment, the hot press and channel plate are designed such that there is an elastic element in the hot press for each bonding region on the channel plate. This ensures that there is an elastic element at each bonding region with which the tolerances described above are compensated for.

It is particularly preferred that the base plate and channel plate are heated, in particular by the hot press, to a temperature of at least 100° C., preferably 120° C. to 250° C., particularly preferably 150° C. to 220° C. This ensures that the glue will be liquified sufficiently, such that it can spread out over the entire bonding region between the channel plate and base plate. In this variation, the channel plate and base plate are also cooled to a maximum temperature of 70° C., preferably between 10° C. and 50° C. This ensures that the adhesive layer can cure sufficiently.

A particularly effective adhesion of the channel plate to the base plate at the at least one bond on the channel plate can be obtained with another preferred embodiment, according to which the base plate and channel plate are pressed together by the hot press and/or cold press with a pressure of 0.05 N/mm² to 1 N/mm², preferably 0.1 N/mm² to 1 N/mm².

An optimal liquification of the glue to create the material bond between the base plate and the channel plate can be obtained when the base plate is placed with the channel plate in the hot press for a (first) time period of 10 seconds to 30 minutes, preferably 10 second to 10 minutes, particularly preferably 30 seconds to 7 minutes.

In another preferred embodiment, the hot press has a receiver for the base plate and the channel plate, and a stamp at a spacing to the receiver, that can be moved toward the receiver. The at least one elastic element extends from the stamp toward the receiver, with which the channel plate can be pressed against the base plate at the at least one bonding region.

In another preferred embodiment, the channel plate and base plate are cooled in the cold press to a maximum temperature of 70° C., preferably 10° C. to 50° C. This ensures that the adhesive layer can sufficiently cure after it has been heated.

An optimal curing of the glue forming the material bond between the base plate and channel plate can be obtained when the base plate is pressed against the channel plate in the cold press for a (second) time period of 10 seconds to 30 minutes, preferably 10 seconds to 10 minutes, particularly preferably 30 seconds to 7 minutes.

According to another advantageous development of the method according to the invention, it comprises a step a0) prior to step a). In this step a0), the adhesive layer is formed by either coating the entire surface of the base plate or channel plate with the glue, or by only coating parts of the surfaces of the base plate or channel plate where the bonds will be formed. In the first version, it is ensured that there will always be glue, regardless of where the components come in contact with one another, with which the adhesion forming the material bond between the base plate and channel plate is obtained. In the second version, no adhesive layer is applied in the channel regions on the channel plate, since no glue is needed there.

In another preferred embodiment, the glue forming the adhesive layer is applied to the base plate or channel plate in a lamination process, with a roller, a dispenser, or by spreading or pressing it thereon. The person skilled in the art can thus select the appropriate method from these options for the specific application.

The invention also relates to a component for a heat exchanger, produced with the method described above, such that the above advantages of the method according to the invention also apply to the component according to the invention.

In a preferred embodiment of the component according to the invention, it extends along a direction of extension. The base plate is substantially flat, while the channel plate is curved, at least in sections. Furthermore, the base plate and channel plate can be joined in at least two regions that are spaced apart in this embodiment by the glue or adhesive layer, which is placed between the base plate and channel plate, at least in the bonding regions, with which the material bond is obtained, such that there is at least one channel region formed where the channel plate is spaced apart from the base plate, resulting in a fluid channel between the channel boundary region and the base plate.

The invention also relates to a press, preferably a hot press that can be heated electrically, for producing a component for a heat exchanger through which fluid can flow by executing the method according to the invention described above. The advantages of the method according to the invention described above also apply to the component according to the invention. The press, or hot press, comprises a receiver for the base plate and channel plate. The press, or hot press, also comprises a stamp at a spacing to the receiver, that can be moved toward the receiver, from which at least one elastic element protrudes, for pressing the channel plate against the base plate in the at least one bonding region.

In a preferred embodiment of the hot press according to the invention, the stamp and/or the receiver can be heated. Consequently, not only a mechanical, but also a thermal contact is obtained between the hot press and the components when pressure is applied. As a result, the adhesive layer with which the material bond between the base plate and the channel plate is obtained when the two components are pressed together is heated to a temperature of at least 100° C., preferably between 120° C. and 250° C., particularly preferably between 150° C. and 220° C.

In an advantageous development, at least one elastic element in the hot press can form an extension of a projection protruding from the stamp toward the receiver. This at least one elastic element can also be inserted in a recess in the stamp, such that it extends therefrom toward the receiver. Both versions allow the elastic element to be secured to the stamp in the hot press.

In a preferred embodiment, the receiver can comprise a receiving plate, or it can be designed as a receiving plate, in particular with a flat surface.

The invention also relates to an assembly for producing a component for a heat exchanger through which a fluid can flow by executing the method according to the invention described above. The advantages of the method according to the invention described above therefore also apply to the assembly according to the invention. The assembly also comprises a cold press for clamping the base plate to the channel plate, such that the adhesive layer is cooled to a maximum temperature of 70° C., preferably 10° C. to 50° C. The cold press can be connected to a coolant reservoir for this.

In a preferred embodiment, the assembly comprises a conveyor for conveying the base plate and channel plate to the hot press and the cold press. This design is used for a partially or fully automated execution of the method according to the invention.

According to one advantageous embodiment, the conveyor has a conveyor belt on which the base plate and channel plate are placed and transported to the hot press and then to the cold press. The hot press and cold press are placed along the conveyor for this. This conveyor belt is available commercially, and is used for mass production of components.

Further important features and advantages of the invention can be derived from the dependent claims, the drawings, and the descriptions of the drawings.

It is understood that the features specified above and described below can be used not only in the given combinations, but also in other combinations or in and of themselves, without abandoning the framework of the present invention.

Preferred exemplary embodiments of the invention are shown in the drawings, and shall be explained in greater detail below, in which identical reference symbols are given to the same, similar, or functionally identical components.

Further important features and advantages of the invention can be derived from the dependent claims, the drawings, and the descriptions of the drawings.

It is understood that the features specified above and described below can be used not only in the given combinations, but also in other combinations or in and of themselves, without abandoning the framework of the present invention.

Preferred exemplary embodiments of the invention are shown in the drawings, and shall be explained in greater detail below, in which identical reference symbols are given to the same, similar, or functionally identical components.

Therein, schematically:

FIGS. 1 to 3 illustrate the method according to the invention, and

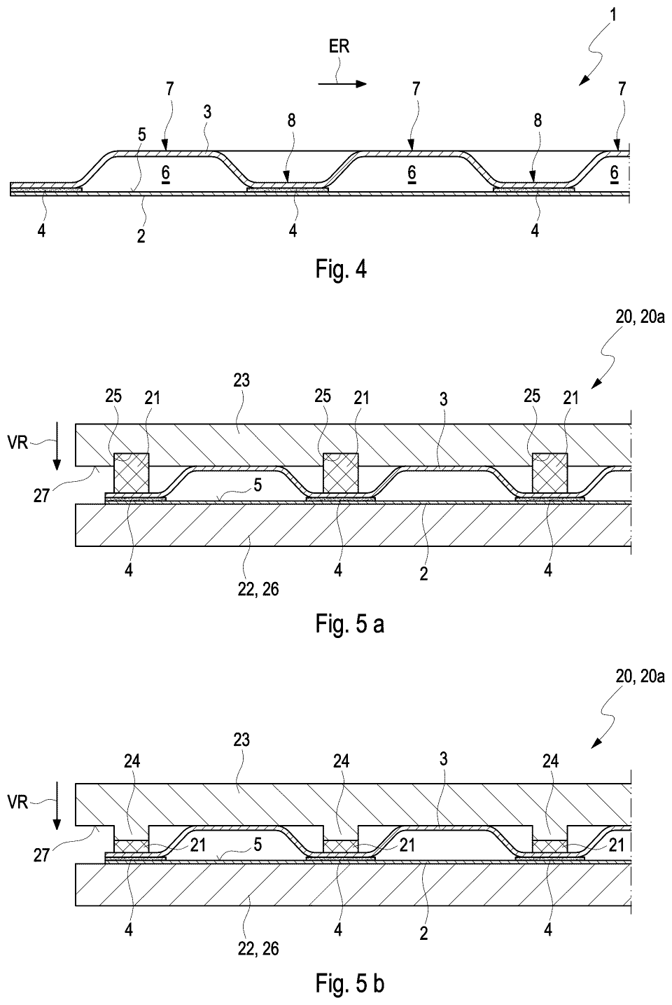

FIG. 4 shows an example of a component according to the invention, and

FIGS. 5a, 5b show variations of the examples shown in FIGS. 1 to 3.

The method according to the invention for producing a component 1 according to the invention, the longitudinal section of which is shown in FIG. 4 in a highly simplified illustration, shall be explained below in reference to FIGS. 1 to 3. The component 1 extends along a direction of extension ER in the longitudinal section shown in FIG. 4. The component 1 comprises a flat base plate 2 and a curved channel plate 3. The channel plate 3 can be corrugated in this direction.

The channel plate 3 is materially bonded to the base plate 2 at numerous separate bonding regions 8 by an adhesive layer 4 formed by a glue, and has numerous channel regions 7 spaced apart from the base plate 2, such that each channel region 7 forms a fluid channel 6 with the base plate 2. The channel boundary regions 7 and the bonding regions 8 alternate along the direction of extension ER.

The component 1 according to the invention is produced with the assembly 40 according to the invention, roughly illustrated schematically in FIGS. 1 to 3.

The assembly 40 comprises a press 20a formed by a hot press 20 for clamping the base plate 2 to the channel plate 3 while heating the adhesive layer 4 on the base plate 2. The hot press 20 can be heated with electricity. The hot press 20 comprises a receiver 22 for the base plate 2 and the channel plate 3. The receiver 22 can be a plate 26 with a flat surface on which the flat base plate 2 can be placed. The hot press 30 can also have a moving stamp 23 at a spacing to the receiver 22.

The assembly 40 also comprises a separate cold press 30 for clamping the base plate 2 to the channel plate 3, and cooling the adhesive layer 4. The cold press 30 also comprises a receiver 32 for the base plate 2 and the channel plate 3. This receiver 32 can also be a plate 36 with a flat surface for the flat base plate 2. The cold press 30 can also have a moving stamp 33 at a spacing to the receiver 32. The cold press can be connected to a coolant reservoir (not shown):

As can be seen in FIG. 1, the assembly 40 can contain a conveyor 41 for conveying the base plate 2 and channel plate 3 to the hot press 20 and then to the cold press 30. The conveyor 41 comprises a conveyor belt 42, on which the base plate 2 and channel plate 3 are placed and can be conveyed in the direction of transport TR to the hot press 20 and then to the cold press 30. The hot press 20 and cold press 30 are next to one another along the direction of transport TR. In this example, the direction of extension ER for the base plate 2 and channel plate 3 is identical to the direction of transport TR. The two stamps 23 and 33 can be moved in a direction VR, which is perpendicular to the direction of transport TR.

The method according to the invention described below comprises four steps a) to d).

In a first step a), a base plate 2 is provided, as shown in FIG. 1, and placed on the conveyor belt 42 in the conveyor 41. An adhesive layer 4 is placed on the surface 5 of the base plate 2 in the bonding regions 8.

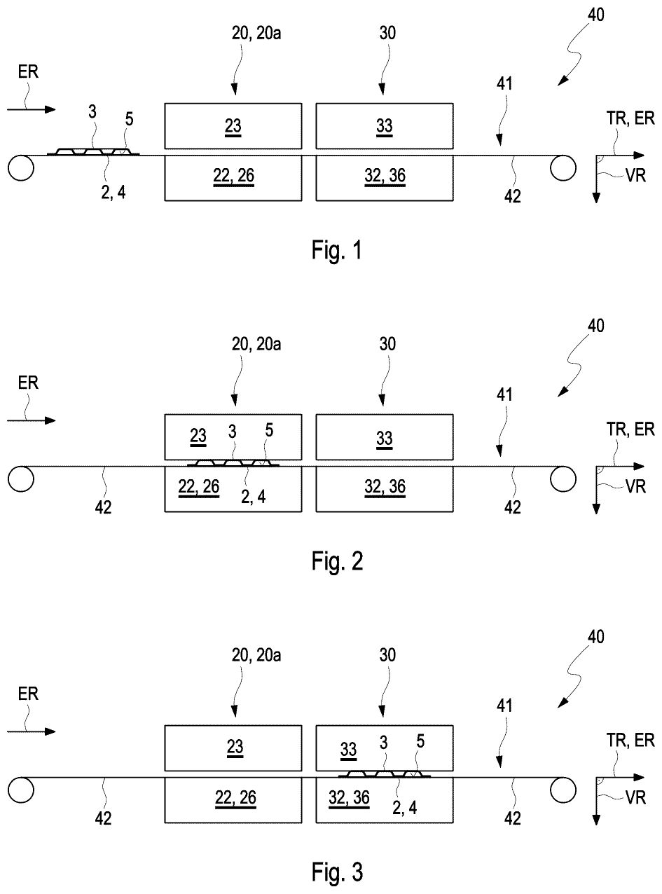

In a second step b), the channel plate 3 is placed on the surface 5 of the base plate 2 such that the channel plate 3 is spaced apart from the base plate in numerous channel regions 7 to obtain the fluid channels 6 (see FIG. 4), and bears on the base plate 2 in the bonding regions 8 to materially bond with the adhesive layer 4. The base plate 2 and channel plate 3 can be conveyed to the receiver 22 in the hot press by the conveyor belt 42 in the conveyor 41. This is shown in FIG. 2.

In a third step c), the channel plate 3 and base plate 2 are pressed together by a clamp 20a formed by the hot press 20, such that the adhesive layer 4 is heated in the bonding regions 8 (not visible in FIGS. 1 to 3, see FIG. 4) between the base plate 2 and the channel plate 3, to obtain a material bond.

By moving the stamp 23 toward the receiver 22, the channel plate 3 is pressed against the base plate 2. A predefined pressure is exerted by the stamp 23 on the channel plate 3 in the known manner. Because both the stamp 23 and the receiver 22, or receiver plate 26 can be heated, the stamp 23 is not only in mechanical contact, but also thermal contact with the channel plate 3, and the receiver is also in both mechanical and thermal contact with the base plate 2. This heats the adhesive layer 4 on the base plate while the channel plate 3 is pressed against the base plate 2. To obtain the material bond between the base plate 2 and the channel plate 3, the adhesive layer 4 is heated to a temperature of at least 100° C., preferably between 120° C. and 250° C., particularly preferably 150° C. to 220° C. The base plate 2 and the channel plate 3 can be pressed together in the hot press 20 with a pressure generated by the stamp 23 that is between 0.05 N/mm² and 1 N/mm², preferably between 0.1 N/mm² and 1 N/mm².

In this example, the base plate 2 and the channel plate 3 are placed in the hot press 20 for a first time period T1 of 10 seconds to 30 minutes, preferably 10 seconds to 10 minutes, particularly preferably 30 second to 7 minutes.

After clamping and heating in the hot press 20, the base plate 2 is conveyed with the channel plate 3 by the conveyor belt 42 in the conveyor 41 from the hot press 20 to the receiver 32 in the cold press 30. This is shown in FIG. 3.

In a fourth step d), the base plate 2 and channel plate 3 are cooled in the cold press 30 while the base plate 2 is pressed against the channel plate 3. The cold press 30 is connected to a coolant reservoir (not shown) for this.

By moving the stamp 33 in the cold press 30 toward the receiver, the channel plate 3 can be pressed against the base plate 2 in the receiver 32. Because the stamp 33 and the receiver 32 in the cold press 30 are both connected to a coolant reservoir (not shown), the base plate 2, channel plate 3, and adhesive layer 4 are cooled through the mechanical and thermal contact to the cold press 30, its stamp 33, and its receiver 32.

The channel plate 3 and base plate 2 are cooled by this means in the cold press 30 to a maximum temperature of 70° C., preferably between 10° C. and 50° C. The base plate 2 and channel plate 3 can be clamped in the cold press 30 at a pressure generated by the stamp in the cold press 30 of 0.05 N/mm² to 1 N/mm², preferably 0.1 N/mm² to 1 N/mm².

In this example, the base plate 2 is placed in the cold press 30 for a second time period T2 of 10 seconds to 30 minutes, preferably 10 seconds to 10 minutes, particularly preferably 30 seconds to 7 minutes.

The component 1 according to the invention is finished after it has cooled off, and can be removed from the cold press 30 by the conveyor belt 42 in the conveyor 41.

The method according to the invention can contain a step a0) prior to the step a) (not shown in the drawings). In this step a0), the adhesive layer 4 is formed by either completely coating the surface 5 of the base plate 2 with the glue, or by coating the bonding regions 8 on the surface 5 of the base plate 2.

FIGS. 5a and 5b show variations of the press 20a. The press 20a in the example shown in FIGS. 5a and 5b cannot be heated. To heat the adhesive layer 4, the press 20a can be placed in an oven, not shown in the figures. The press 20a in FIGS. 5a and 5b can contain a receiver 22 or receiver plate 26, and a stamp 23 that can be moved toward the receiver 22, like the hot press 20 shown in FIGS. 1 to 3.

In the example shown in FIG. 5a, numerous spaced apart elastic elements 21 protrude from the stamp 23 toward the receiver 22. Pressure can be exerted on the bonding regions 8 in the channel plate 3 by the elastic elements 21, such that these bonding regions 8 in the channel plate 3 are pressed against the base plate 2 supported on the receiver 22. The hot press 20 and the channel plate 3 are designed such that there is an elastic element 21 in the hot press 20 for each bonding region 8 in the channel plate 3. Each bonding region 8 therefore has a dedicated elastic element 21. There is a recess 25 for each elastic element 21 on the side 27 of the stamp 23 facing the receiver 22, in which each elastic element 21 is partially accommodated such that it protrudes from the recess 25 toward the receiver 22.

FIG. 5b shows a variation of the example in FIG. 5a. The example in FIG. 5b differs from that in FIG. 5a in that the elastic elements 21 are not accommodated in recesses 25 on the stamp 23. Instead, there is a projection 24 protruding from the stamp 23 toward the receiver 22 for each elastic element 21 on the side 27 of the stamp 23 facing the receiver 22 in the example shown in FIG. 5b, preferably as an integral part thereof, which is then extended toward the receiver 22 by an elastic element 21.

In two other variations, not shown in the drawings, the variations shown in FIGS. 5a and 5b can be hot presses 20, like those described in reference to FIGS. 1 to 3.

In the above example, only the base plate 2 is coated with the glue forming the adhesive layer 4. It is also possible to coat the channel plate 3 with an adhesive layer 4 formed by glue.

The specification can be readily understood with reference to the following Numbered Paragraphs:

Numbered Paragraph 1. A method for producing a component (1) for a heat exchanger through which fluid can flow, comprising the following steps:
a) providing a base plate (2) and a channel plate (3), wherein an adhesive layer (4) formed by glue is placed on the surface (5) of the base plate (2) and/or the channel plate (3), at least in specific areas,
b) placing the channel plate (3) on the surface (5) of the base plate (2) such that the channel plate (3) is spaced apart from the base plate (2) to delimit at least one fluid channel (6) in at least one channel region (7), and bears on the adhesive layer (4) on the base plate (2) and/or the channel plate (3) to obtain a material bond in at least one bonding region (8),
c) clamping the channel plate (2) to the base plate (6) in, or with, a hot press (20), such that a material bond is obtained in the at least one bonding region (8) between the base plate (2) and the channel plate (3) when the adhesive layer (4) is heated.

Numbered Paragraph 2. The method according to Numbered Paragraph 1, characterized in that the clamping by the press (20) only takes place in the at least one bonding region (8).

Numbered Paragraph 3. The method according to Numbered Paragraph 1 or 2, characterized in that there is an elastic element (21) in the press (20a), with which a pressure is exerted on the at least one bonding region (8) in the channel plate (3).

Numbered Paragraph 4. The method according to any of the Numbered Paragraphs 1 to 3, comprising the following step d), which follows step c):
d) placing the base plate (2) and the channel plate (3) in a cold press (30), such that the adhesive layer (4) is cooled while under pressure.

Numbered Paragraph 5. The method according to any of the preceding Numbered Paragraphs, characterized in that a channel plate (3) is provided in step a), with which at least two, preferably more, bonding regions (8) and at least two, preferably more, channel regions (7) are formed in step b).

Numbered Paragraph 6. The method according to any of the preceding Numbered Paragraphs, characterized in that the press (20a), in particular the hot press (20), and the channel plate (3) are designed such that there is an individual elastic element (21) in the press (20a), or hot press (20), for each bonding region (8) in the channel plate (3).

Numbered Paragraph 7. The method according to any of the preceding Numbered Paragraphs, characterized in that the base plate (2) and the channel plate (3) are heated in the hot press (20) to a temperature of at least 100° C., preferably between 120° C. and 250° C., particularly preferably between 150° C. and 220° C.

Numbered Paragraph 8. The method according to any of the preceding Numbered Paragraphs, characterized in that the base plate (2) and channel plate 3) are pressed together with a pressure generated by the hot press with the at least one elastic element (21) of 0.05 N/mm² to 1 N/mm², preferably 0.1 N/mm² to 1 N/mm².

Numbered Paragraph 9. The method according to any of the preceding Numbered Paragraphs, characterized in that the base plate (2) and channel plate (3) are placed in the press (20a), in particular the hot press (20), for a (first) time period (T1) of 10 seconds to 30 minutes, preferably 10 seconds to 10 minutes, particularly preferably 30 seconds to 7 minutes.

Numbered Paragraph 10. The method according to any of the preceding Numbered Paragraphs, characterized in that the press (20a), in particular the hot press (20), has a receiver (22) for the base plate (2) and the channel plate (3), and a moving stamp (23) at a spacing to the receiver (22) that can be moved toward the receiver (22), from which the at least one elastic element (21) projects toward the receiver (22) to press the channel plate (2) against the base plate (2) at the at least one bonding region (8).

Numbered Paragraph 11. The method according to any of the preceding Numbered Paragraphs, characterized in that the channel plate (3) and the base plate (2) are cooled to a maximum temperature of 70° C., preferably between 10° C. and 50° C.

Numbered Paragraph 12. The method according to any of the preceding Numbered Paragraphs, characterized in that the base plate (2) and the channel plate (3) are placed in the cold press for a (second) time period of 10 seconds to 30 minutes, preferably 10 seconds to 10 minutes, particularly preferably 30 seconds to 7 minutes.

Numbered Paragraph 13. The method according to any of the preceding Numbered Paragraphs, comprising a step a0) prior to step a), in which
the adhesive layer (4) is formed by completely coating the surface (5) of the base plate (2) or the channel plate (3) with the glue, or
the adhesive layer (4) is formed by coating only those parts of the surface (5) of the base plate (2) or channel plate (3) where the at least one bonding region (8) is to be formed.

Numbered Paragraph 14. The method according to any of the preceding Numbered Paragraphs, characterized in that the glue is applied to the base plate (2) and/or the channel plate (3) in a lamination process, with a roller, a dispenser, or by spreading or pressing it thereon.

Numbered Paragraph 15. A component (1) for a heat exchanger, produced with the method according to any of the preceding Numbered Paragraphs.

Numbered Paragraph 16. The component according to Numbered Paragraph 15, characterized in that
the component (1) extends along the direction of extension (ER),
in a longitudinal section along the direction of extension (ER),
the base plate (2) is substantially flat,
the channel plate (3) is curved, at least in sections,
the base plate (2) and channel plate (3) are materially bonded by the glue in at least two bonding regions (8) that are spaced apart from one another, and the channel plate is spaced apart from the base plate (2) in at least one channel region (7), such that the at least one channel region (7) forms a fluid channel (6) with the base plate (2).

Numbered Paragraph 17. A press (20a), in particular a hot press (20) for producing a component (1) for a heat exchanger through which fluid can flow by executing the method according to any of the preceding Numbered Paragraphs, containing
a receiver (22) for the base plate (2) and the channel plate (3),
with a moving stamp (23) at a spacing to the receiver (22) that can move in relation to the receiver (22), from which the at least one elastic element protrudes toward the receiver (22) to press the channel plate (3) against the base plate (2) at the at least one bonding region (8).

Numbered Paragraph 18. The press according to Numbered Paragraph 17, characterized in that the stamp (23) and/or the receiver (22) can be heated, such that while the base plate is pressed against the channel plate (2), the adhesive layer (4) on the base plate (3) can be heated to a temperature of at least 100° C., preferably between 120° C. and 250° C., particularly between 150° C. and 220° C., to obtain a material bond between the base plate (2) and the channel plate (3) with the adhesive layer (4).

Numbered Paragraph 19. The press according to Numbered Paragraph 17 or 18, characterized in that
at least elastic element (21) forms an extension of a projection (24) protruding from the stamp (23) toward the receiver (2), and/or
at least one elastic element (21) is accommodated in part in a recess (25) in the stamp (23), and protrudes from this recess (25) toward the receiver (22).

Numbered Paragraph 20. The press according to any of the Numbered Paragraphs 17 to 19, characterized in that the receiver (22) comprises a receiver plate (26) or forms a receiver plate (26).

Numbered Paragraph 21. An assembly (40) for producing a component (1) for a heat exchanger through which fluid can flow by executing the method according to any of the Numbered Paragraphs 1 to 14, containing
a press (20a), in particular a hot press (20), according to any of the Numbered Paragraphs 17 to 20,
a cold press (30) for clamping the base plate (2) to the channel plate (3), such that the adhesive layer (4) is cooled to a maximum temperature of 70° C., preferably 10° C. to 50° C.

Numbered Paragraph 22. The assembly according to Numbered Paragraph 21, characterized in that the assembly (1) comprises a conveyor (41) for conveying the base plate (2) and the channel plate (3) to the press (20a), or hot press (20), and the cold press (30) successively.

Numbered Paragraph 23. The assembly according to Numbered Paragraph 21 or 22, characterized in that the conveyor comprises a conveyor belt (42) that can move in relation to the press (20a), or hot press (20), and the cold press (30), on which the base plate (2) is placed with the channel plate (3), and can be transported in a direction of transport (TR), wherein the press (20a), or hot press (20), and the cold press (30) are located along the conveyor (TR).

1. A method for producing a component for a heat exchanger through which fluid can flow, comprising the following steps:
a) providing a base plate and a channel plate, wherein an adhesive layer formed by glue is placed on the surface of the base plate and/or the channel plate, at least in specific areas,
b) placing the channel plate on the surface of the base plate such that the channel plate is spaced apart from the base plate to delimit at least one fluid channel in at least one channel region, and bears on the adhesive layer on the base plate and/or the channel plate to obtain a material bond in at least one bonding region,
c) clamping the channel plate to the base plate in, or with, a hot press, such that a material bond is obtained in the at least one bonding region between the base plate and the channel plate when the adhesive layer is heated.

2. The method according to claim 1, wherein the clamping by the press only takes place in the at least one bonding region.

3. The method according to claim 1, further comprising an elastic element in the press, with which a pressure is exerted on the at least one bonding region in the channel plate.

4. The method according to claim 1, comprising the following step d), which follows step c):
d) placing the base plate and the channel plate in a cold press, such that the adhesive layer is cooled while under pressure.

5. The method according to claim 1, wherein a channel plate is provided in step a), with which at least two, bonding regions and at least two channel regions are formed in step b).

6. The method according to claim 1, wherein the press, in particular the hot press, and the channel plate are designed such that there is an individual elastic element in the press, or hot press, for each bonding region in the channel plate.

7. The method according to claim 1, wherein the base plate and the channel plate are heated in the hot press to a temperature of at least 100° C.

8. The method according to claim 1, wherein the base plate and channel plate 3) are pressed together with a pressure generated by the hot press with the at least one elastic element of 0.05 N/mm² to 1 N/mm².

9. The method according to claim 1, wherein the base plate and channel plate are placed in the press, in particular the hot press, for a time period (T1) of 10 seconds to 30 minutes.

10. The method according to claim 1, wherein the press, in particular the hot press, has a receiver for the base plate and the channel plate, and a moving stamp at a spacing to the receiver that can be moved toward the receiver, from which the at least one elastic element projects toward the receiver to press the channel plate against the base plate at the at least one bonding region.

11. The method according to claim 1, characterized in that the channel plate and the base plate are cooled to a maximum temperature of 70° C.

12. The method according to claim 1, wherein the base plate and the channel plate are placed in the cold press for a time period of 10 seconds to 30 minutes.

13. The method according to claim 1, comprising a step a0) prior to step a), in which
the adhesive layer is formed by completely coating the surface of the base plate or the channel plate with the glue, or
the adhesive layer is formed by coating only those parts of the surface of the base plate or channel plate where the at least one bonding region is to be formed.

14. The method according to claim 1, wherein the glue is applied to the base plate and/or the channel plate in a lamination process, with a roller, a dispenser, or by spreading or pressing it thereon.

15. (canceled)

16. A component for a heat exchanger, produced with the method according to claim 1, wherein
the component extends along the direction of extension (ER),
in a longitudinal section along the direction of extension (ER),
the base plate is substantially flat,
the channel plate is curved, at least in sections,
the base plate and channel plate are materially bonded by the glue in at least two bonding regions that are spaced apart from one another, and the channel plate is spaced apart from the base plate in at least one channel region, such that the at least one channel region forms a fluid channel with the base plate.

17. A press, in particular a hot press for producing a component for a heat exchanger through which fluid can flow by executing the method according to claim 1, containing
a receiver for the base plate and the channel plate,
with a moving stamp at a spacing to the receiver that can move in relation to the receiver, from which the at least one elastic element protrudes toward the receiver to press the channel plate against the base plate at the at least one bonding region.

18. The press according to claim 17, wherein the stamp and/or the receiver can be heated, such that while the base plate is pressed against the channel plate, the adhesive layer on the base plate can be heated to a temperature of at least 100° C. to obtain a material bond between the base plate and the channel plate with the adhesive layer.

19. The press according to claim 17, wherein
at least elastic element forms an extension of a projection protruding from the stamp toward the receiver, and/or
at least one elastic element is accommodated in part in a recess in the stamp, and protrudes from this recess toward the receiver.

20. The press according to claim 17, wherein the receiver comprises a receiver plate or forms a receiver plate.

21. An assembly for producing a component for a heat exchanger through which fluid can flow by executing the method according to claim 1, containing
a press, in particular a hot press for producing a component for a heat exchanger through which fluid can flow, comprising, a receiver for the base plate and the channel plate,
with a moving stamp at a spacing to the receiver that can move in relation to the receiver, from which the at least one elastic element protrudes toward the receiver to press the channel plate against the base plate at the at least one bonding region,
a cold press for clamping the base plate to the channel plate, such that the adhesive layer is cooled to a maximum temperature of 70° C., preferably 10° C. to 50° C.

22. The assembly according to claim 21, wherein the assembly comprises a conveyor for conveying the base plate and the channel plate to the press, or hot press, and the cold press successively.

23. The assembly according to claim 21, wherein the conveyor comprises a conveyor belt that can move in relation to the press, or hot press, and the cold press, on which the base plate is placed with the channel plate, and can be transported in a direction of transport, wherein the press, or hot press, and the cold press are located along the conveyor (TR).
